(19) United States
(12) Patent Application Publication
(10) Pub. No.: US 2017/0227943 A1
(43) Pub. Date: Aug. 10, 2017

(54) Device and Method for Calculating Optimum Values Using a Proportional-Integral-Derivative (PID) Control Loop

(71) Applicant: William Franklin Salyers, III, Franklin Furnace, OH (US)

(72) Inventor: William Franklin Salyers, III, Franklin Furnace, OH (US)

(21) Appl. No.: 15/425,724

(22) Filed: Feb. 6, 2017

Related U.S. Application Data
(60) Provisional application No. 62/291,637, filed on Feb. 5, 2016.

(51) Int. Cl. G05B 19/042

(52) U.S. Cl. CPC G05B 19/0426; G05B 2219/41181

(57) ABSTRACT

A device and method for calculating optimum values using a proportional-integral-derivative (PID) control loop. A user may select from a list of manufacturers, devices, systems and applications. The user selects the appropriate combination, and a set of parameters from a pre-populated database is loaded. The user may adjust any of the default values if so desired. The present invention also provides the ability to adjust optional fields based on specific manufacture PID algorithms, such as minimum output and maximum output, PID execution rate, and percentage of stage capacity per design. Optimum PID parameters are calculated based on the specific device and optional field values and are used by a PID control unit to have the device efficiently achieve desired results.

### CROSS REFERENCE TO RELATED APPLICATIONS

This application claims the benefit of U.S. Provisional Application No. 62/291,637 filed on Feb. 5, 2016. The above identified patent application is herein incorporated by reference in its entirety to provide continuity of disclosure.

### BACKGROUND OF THE INVENTION

The present invention relates to a method of optimizing the accuracy and precision of variables used in PID control units within the industrial field. The proportional-integral-derivative (PID) control function is used in the majority of the direct digital controllers throughout numerous industries. Utilizing the three step PID process allows systems to achieve optimum performance in a variety of applications. Current PID tuning methods are both complicated and time consuming, limiting industry capabilities to properly set PID tuning parameters in order to achieve optimum performance levels. Inefficient PID calculations result in lost time, less accurate results and ultimately reduced productivity and efficiency. Accordingly, an improved PID calculation method that is configured to alleviate inefficiencies and inconsistencies in PID tuning is desired.

### SUMMARY OF THE INVENTION

In view of the foregoing disadvantages inherent in the known types of methods of optimizing the parameters used in digital controllers now present in the prior art, the present invention provides a method of optimizing PID controllers wherein the same can be utilized for providing convenience for the user when wishing to efficiently calculate accurate parameters for use in digital controllers. The present invention comprises a system and method for calculating optimum values to tune each proportional-integral-derivative (PID) control loop according to the intended use within a specific system and application.

The method for calculating optimized PID parameters includes the following steps: selecting a manufacturer, selecting a device, selecting the particular system, and selecting the desired application. In each of the steps the logic interacts with a database having various system applications parameters stored therein. Further, the system provides optional field values based on each manufacture's device PID algorithm and nomenclature, such as minimum output and maximum output, PID execution rate, percentage of stage capacity per design and the like. The PID parameter values are then calculated for optimum efficiency and performance.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a schematic view of one embodiment of the device for calculating optimum values using a proportional-integral-derivative (PID) control loop.

FIG. 2 shows a diagram view of the PID control loop.

FIG. 3A shows a chart of a sample pump schedule.

FIG. 3B shows a chart of a sample air handling unit schedule.

FIG. 4 shows a flow chart of one embodiment of the method for calculating optimum values using a proportional-integral-derivative (PID) control loop.

FIG. 5 shows a graphical user interface for implementing the method for calculating optimum values using a proportional-integral-derivative (PID) control loop

### DETAILED DESCRIPTION OF THE INVENTION

Reference is made herein to the attached drawings. Like reference numerals are used throughout the drawings to depict like or similar elements of the method for calculating optimum values using a proportional-integral-derivative (PID) control loop. The figures are intended for representative purposes only and should not be considered to be limiting in any respect.

As used herein, “logic” refers to (i) logic implemented as computer instructions and/or within one or more computer processes and/or (ii) logic implemented in electronic circuitry. As used herein, “computer-readable medium” excludes any transitory signals, but includes any non-transitory data storage circuitry, e.g. buffer cache, and queues, within transceivers of transitory signals. In the interest of economy, the present disclosure refers to “computer-readable medium,” “a processor,” “a database,” and so on. However, this should not be read as limiting in any way as the present disclosure contemplates embodiments of the present invention utilizing “one or more computer readable media,” “one or more processors,” “one or more databases,” and so on. Unless specifically limited to a single unit, “a” is intended to be equivalent to “one or more” throughout the present disclosure.”

According to some embodiments, the operations, techniques, and/or components described herein can be implemented as (i) a special-purpose computing device having specialized hardware and a logic hardwired into the computing device to persistently perform the disclosed operations and/or techniques or (ii) a logic that is implementable on an electronic device having a general purpose hardware processor to execute the logic and a computer-readable medium, e.g. a memory, wherein implementation of the logic by the processor on the electronic device provides the electronic device with the function of a special-purpose computing device.

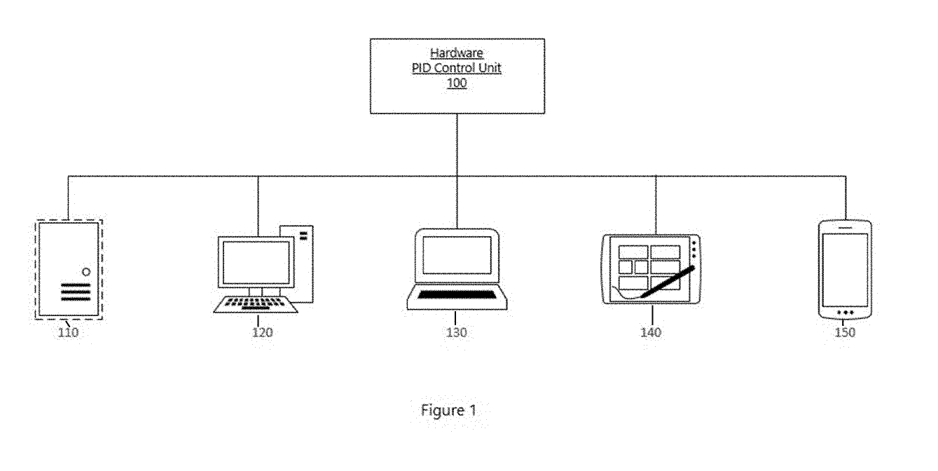

Referring now to FIG. 1, there is shown a schematic view of one embodiment of the device for calculating optimum values using a proportional-integral-derivative (PID) control loop. The present invention comprises a PID control unit 100 operably connected to a database 110 and a logic 120 having a computer-readable memory. In some embodiments, multiple logics, such as client terminals 130, tablet computers 140 or mobile devices 150 may be used. Some of the logics incorporate a display unit to present a graphical user interface.

The PID control unit is configured to run the PID control loop, as described below, while accessing stored information including optimum PID parameter from the database 110. The method for Calculating Optimum Values Using a Proportional-Integral-Derivative (PID) Control Loop may be executed on logic of any of the shown devices. In some embodiments, the database is stored locally relative to the logic, while in other embodiments the database may be accesses remotely.

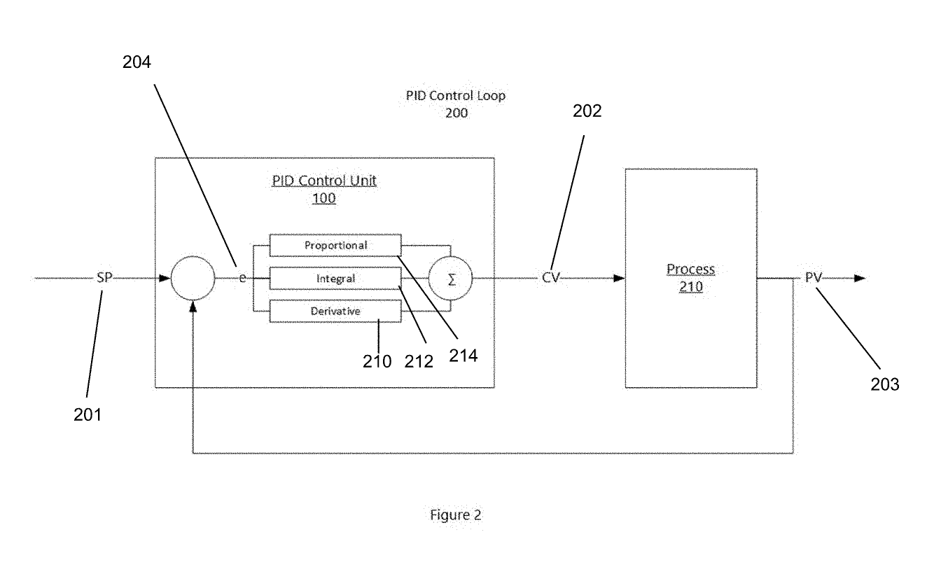

Referring now to FIG. 2, there is shown a diagram view of a PID control loop. The PID control loop 200 comprises a PID control unit 100 controlling a process 210. The PID control unit 100 has two or more input values and one output value. The input values include a set point (SP) 201 and a process variable (PV) 203, and the output value is referred to as a control variable (CV) 202. The set point 201 is the desired value for the application, the process value 203 is the current measured value and the control variable 202 is the output from the PID control unit 100 configured to bring the process value 203 closer to the set point 201. The difference between the set point 201 and the process variable 203 is the error value, e 204. As the process value 203 approaches the set point 201, the error value 204 approaches zero.

As an example, the PID control unit 100 may be implemented to control the temperature of a room. First, a desired temperature, or set value 201, is determined. A sensor will measure the current temperature of the room and send that value to the PID control unit 100 as the process variable 203. The PID control unit 100 then compares the process value 203 to the set point 201 and subtracts the two variables, leaving the error value 204. The PID control unit 100 will then make various adjustments and output a control variable 202 to an air handling unit in order to minimize that error value. In the current example, the process 210 may involve activating a HVAC unit, with the control variable 202 determining if a cooling coil or heating coil may be activated to achieve the desired set point.

Three types of adjustments are made by the PID control unit 100 to minimize the error value: proportional 214, integral 212 and derivative 210. Proportional 214 adjustments multiply the error value by a predetermined constant. This can either be a positive or negative number depending on the current control variable and the desired set point. The integral adjustment 212 takes into account the magnitude of the error along with the duration of that error. Finally, the derivate adjustment 210 calculates the rate of change of the error value. The control variable 202 is affected by all three adjustments to achieve the desired set 201 point in most efficient manner.

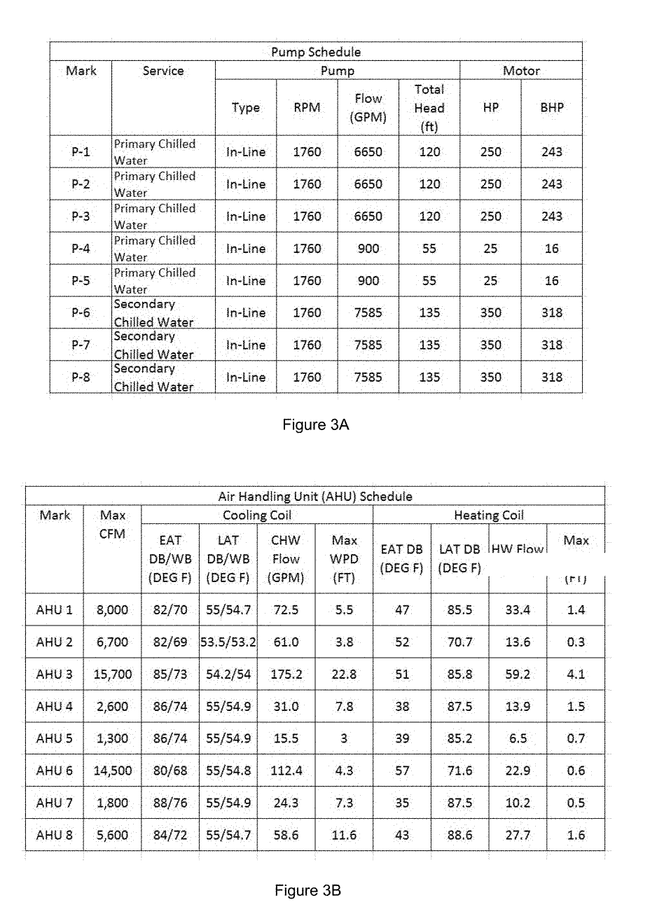

Referring now to FIGS. 3A and 3B, there are shown two charts that illustrate a sample pump schedule and a sample air handling unit schedule for specific hardware, respectively. The sample pump schedule indicates specific parameters that are used by the system application design. When implementing the method for calculating optimum values for a PID control loop, a user first selects a particular system. For example, a pump secondary chilled water system as shown in FIG. 3A may be selected. Each system has various parameters associated with use for particular applications. A user may select between different applications such as flow control for parallel pumping or differential pressure control with parallel pumping. If the flow control for parallel pumping of three pumps is selected as the desired application, the user will enter the combined flow of 22755 GPM into the system application design as the set point for this particular application. Alternatively, a user may select differential pressure control with parallel pumping as the application. In such a case, the user can convert head in feet to pounds per square inch (PSI), and enter a maximum total head of 135 as the set point.

Similarly, FIG. 3B illustrates a schedule of an air handling unit (AHU) for selecting the desired parameters for a heating coil or cooling coiling based on the design specifications of a particular unit. A user first selects a particular system, for example a coil control for a constant volume AHU, and an application as heating coil for leaving air dry bulb temperature control. The user may enter the delta T as the set point, where the delta T is the absolute difference between entering air temperature (EAT) dry bulb (DB) and the leaving air temperature (LAT) dry bulb (DB).

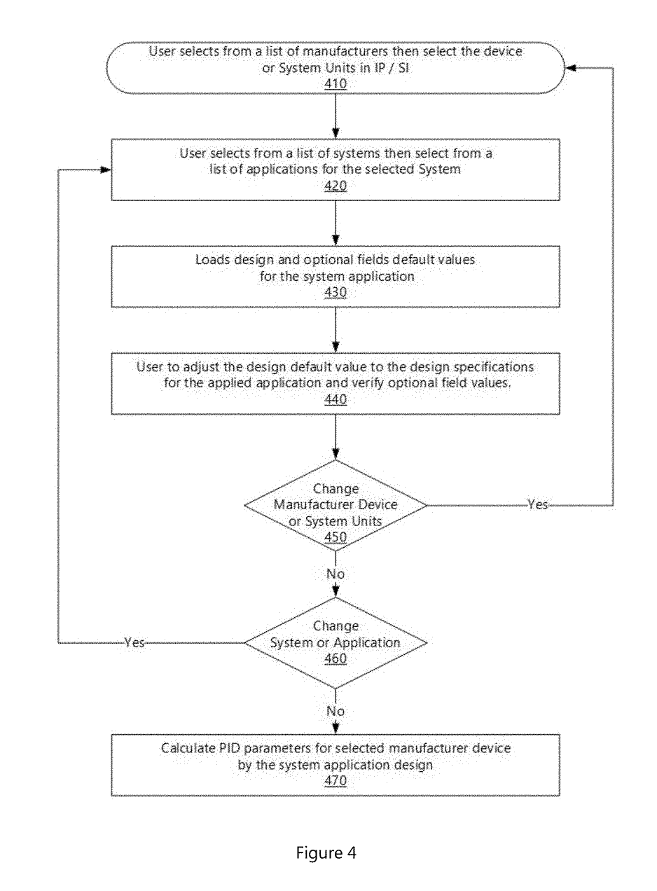

Referring now to FIG. 4, there is shown a flow chart of one embodiment of the method for calculating optimum values using a proportional-integral-derivative (PID) control loop. The method beings with a user first selecting 410 a manufacturer from a list of manufacturers and then selecting one or more devices from a list of devices made by the selected manufacturer. Additionally, the desired units of measurement may be selected, such as IP (imperial) or SI (International System of Units) unit system. The user next selects 420 a system that the device will be used with and a specific set of applications within that system. PID parameters designed for that specific application and for that particular device are loaded from a database onto a computer-readable medium 430. A user is then presented with the option to modify the PID parameters as well as additional optional fields if so desired 440. For example, the optional fields may include minimum output and maximum output, PID execution rate, and percentage of stage capacity per design.

After retrieving these saved settings from the database, the user may be presented with the option of modifying any of the original parameters 450 such as the manufacturer, device, or system units used. This would allow the user to start the method from the beginning using new parameters as a base starting point 410. Additionally, a user may amend the system or application to be used 460. If no further adjustments are desired, the final optimum PID parameters are calculated 470.

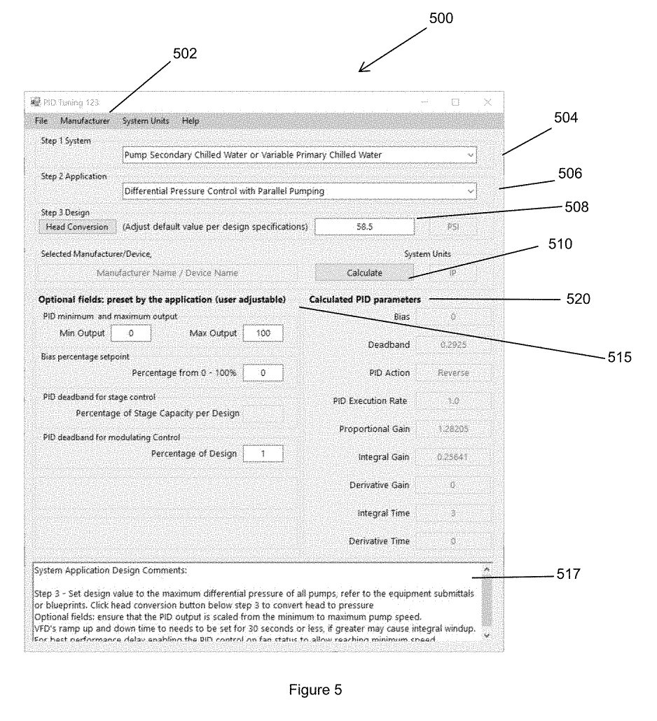

Referring now to FIG. 5, there is shown a graphical user interface 500 for implementing the method for calculating optimum values using a proportional-integral-derivative (PID) control loop. The graphical user interface 500 includes a number of fields for a user to input the starting values for the desired system. A user can use the menu bar 502 to choose a particular manufacturer and device, and select which system units to use, such as imperial units (IP) or international unit (SI). In some embodiments, there is a “Manufacturer” menu option with a nested “Device” menu extending therefrom. Next, in the box labeled Step 1 System 504, a user chooses a system in which the device will be used. A user then chooses a particular application for the selected system in the box labeled Step 2 Application 504. Both the system and the application options have been preloaded from the pre-populated database. Once these variables have been selected, the box labeled Step 3 Design allows the user to adjust the design default values as desired to conform to particular design specifications. For example, a user desiring use the Total Head value in FIG. 3A as the set point may enter that value in the appropriate units.

In addition to the system and application values, there are a number of optional fields 515 that a user may choose to adjust. These may vary depending on the manufacturer and device selected. Examples of these optional fields may include a PID minimum and maximum output, bias percentage set point and PID deadband. Subtracting the PID maximum output from the PID minimum span will be set the PID span. System application design comments 517 may be displayed as well as a quick reference to each design specifications, offering additional information and useful comments.

The various additional variables may include, but are not limited to, span as float, PID as a single or individual, proportional as gain or band, integral and derivative time as none or seconds or minutes or repeat per minute, gain limit value, select deadband as none or half weight or full weight, PID execution time as preset, adjustable. All manufacturer device forms use the same predefined database for the system applications.

When all of the desired variables have been entered, the user may select a button to calculate the optimum PID parameters, which are then displayed in the selected system units. These calculated PID parameters may then be used in the PID control loop to optimum efficiency. A user can adjust the variables after having calculated the PID parameters, but such a change will clear the calculated PID parameters and require a recalculation thereof.

The following is an incomplete listing of variables that may be included within the database and their respective equations:

PID execution rate=PID execution time seconds

Bias=((Span)(Bias %))+(Min Span)

Bias multiplier=(ABS(Bias Constant−Bias %))+Bias Constant

Select deadband as none, half or full and stages enabled as true or false.

Deadband none=0

Deadband half stage=(Design)(DB capacity per stage)(DB half)

Deadband half modulating=(Design)(DB percentage design)

Deadband full stage=(Design)(DB capacity per stage)

Deadband full Modulating=(Design)(DB percentage design)(DB full)

PID as single, individual and Proportional as gain, band and PID control as P, I, PI, PID

Proportional gain=((span/design)(100%−deadtime %)(bias multiplier)),

Proportional band=(100/((span/design)(100%−deadtime %)(bias multiplier)),

Individual Integral gain=((span/design)(100%−deadtime %)(bias multiplier)(IND I gain)),

Individual Integral time seconds=((time constant)(IND I time))

Individual Integral time minutes=(((time constant)(IND I time))/60)

Individual Integral time repeats/minute=(1/(((time constant)(IND I time))/60))

Individual Derivative Gain=0

Individual Derivative Time=0

Proportional/Controller gain=((span/design)(100%−deadtime %)(bias multiplier)),

Proportional band=(100/((span/design)(100%−deadtime %)(bias multiplier)),

Single Integral time seconds=((time constant)(SIN I time))

Single Integral time minutes=(((time constant)(SIN I time))/60)

Single Integral time repeats/minute=(1/(((time constant)(SIN I time))/60))

Single Derivative time=0

The forgoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A method for calculating optimum values using a proportional-integral-derivative control loop, comprising the following steps:
receiving a manufacturer selection;
receiving a device selection specific to the manufacturer;
receiving an application selection for the device to be used with;
loading parameters from a pre-populated database that are associated with the selected manufacturer, device and application;
calculating the optimum proportional-integral-derivative parameters for the selected manufacturer, device and application to be used with a proportional-integral-derivative control loop.

2) The method for calculating optimum values using a proportional-integral-derivative control loop of claim 1, further comprising the following step:
adjusting optional parameter variables for the PID control loop after loading the parameters from the pre-populated database.

3) The method for calculating optimum values using a proportional-integral-derivative control loop of claim 1, wherein the proportional-integral-derivative control loop comprises a proportional-integral-derivative control unit.

4) The method for calculating optimum values using a proportional-integral-derivative control loop of claim 1, further comprising:
displaying a graphical user interface, wherein the graphical user interface includes input controls to select the desired manufacturer, system, application, and is configured to display the calculated optimum proportional-integral-derivative parameters.

5) A device for calculating optimum values using a proportional-integral-derivative control loop, comprising:
a logic,
a pre-populated database operably connected to the logic, the database containing parameters for a proportional-integral-derivative control loop;
a display unit;
wherein the logic is configured to calculate optimum values using a proportional-integral-derivative control loop, comprising:
receiving a manufacturer selection;
receiving a device selection specific to the manufacturer;
receiving an application selection for the device to be used with;
loading parameters from the pre-populated database that are associated with the selected manufacturer, device and application;
calculating the optimum proportional-integral-derivative parameters for the selected manufacturer, device and application to be used with a proportional-integral-derivative control loop;
and wherein the display unit is configured to display a graphical user interface, wherein the graphical user interface includes input controls to select the desired manufacturer, system, application, and is configured to display the calculated optimum proportional-integral-derivative parameters.
